(19) United States
(12) Patent Application Publication
(10) Pub. No.: US 2015/0154800 A1
(43) Pub. Date: Jun. 4, 2015

(54) AUGMENTED REALITY VIEWING INITIATION BASED ON SOCIAL BEHAVIOR

(71) Applicant: Glen J. Anderson, Beaverton, OR (US)

(72) Inventor: Glen J. Anderson, Beaverton, OR (US)

(21) Appl. No.: 14/368,027

(22) PCT Filed: Dec. 4, 2013
(86) PCT No.: PCT/US2013/073168

§ 371 Date: Jun. 23, 2014

(51) Int. Cl. G06T 19/00; H04L 12/26

(52) U.S. Cl. CPC G06T 19/006; H04L 43/10; G06T 2219/024

(57) ABSTRACT

Embodiments of methods for initiating augmented reality viewing and an augmented reality subsystem are disclosed. One such augmented reality method includes monitoring the social behavior of one or more first users in response to an event at a geographical location. The augmented reality content being provided to be displayed on subsystems of the one or more first users may be provided to a subsystem of a second user in response to social behavior of the one or more first users when the second user has a substantially similar geographical location and the subsystem of the second user is oriented to point towards the event.

### BACKGROUND

Augmented reality (AR) viewing may be defined as a live view of a real-world environment whose elements are supplemented (e.g., augmented) by computer-generated sensory input such as sound, video, graphics, and/or GPS data. For example, software applications executed by smartphones may use the smartphone's imagining sensor to capture a real-time event being experienced by a user while overlaying that view, on the smartphone display, with text and/or graphics that supplement the real-time event.

As the popularity of AR viewing increases, various AR standards have been proposed in order to attempt to provide an open architecture to enable AR consumers to be able to use multiple channels of AR content from different vendors. This AR content may be anchored in the same real-time, physical space, but users may be viewing a different one of a set of channels at any given point in time. For example, if a group of people is reacting to AR content in a particular direction, a person separate from the group, not aware of which AR channel the group is using, may have to go through multiple channels of AR content in order to find the one being used by the group. The person may simply by-pass the AR content due to the inconvenience of attempting to find the proper channel

There are general needs for more natural interaction with augmented reality content.

### BRIEF DESCRIPTION OF THE DRAWINGS

FIG. 1 shows a block diagram of an embodiment of an augmented reality (AR) viewing system.

FIGS. 2A and 2B show diagrams of an embodiment of an AR event in accordance with the embodiment of FIG. 1.

FIG. 3 shows a diagram of an embodiment of an AR display in accordance with the embodiments of FIGS. 1 and 2.

FIG. 4 shows a flowchart of an embodiment of a method for AR viewing initiation based on social behavior.

FIG. 5 shows a flowchart of another embodiment of a method for AR viewing initiation based on social behavior.

FIG. 6 shows a block diagram of an embodiment of a computer system in accordance with the AR viewing system of FIG. 1.

### DETAILED DESCRIPTION

End users may have electronic devices (e.g., eyeglasses, smartphones) that may operate with multiple layers of AR imagery from multiple sources. Various AR standards have been proposed in order to provide open architectures to allow end users to consume AR content from multiple providers.

One problem with a user having multiple channels of content is that the user may not be able to access a desired channel fast enough to interact with a particular event in real-time. For example, a user may come upon an event in which a group of people are reacting to the event in combination with a channel of AR content. The user may not be able to find that particular channel of content quickly enough, before the event has ended, in order to determine the source of the group's reaction. The present embodiments of an AR viewing system enable the social behavior of current users of a channel of AR content to affect a display of AR content for a potential AR user.

As used herein, AR content may include any information that may supplement an event. AR content may be visual (e.g., text, graphics), audio (e.g., music, speech, tones), and/or haptic (e.g., vibrations). Also as used herein, the term “social behavior” may include any form of action by users associated with an event and/or interaction by users with the event. The actions or interactions may include visual, haptic, smell, taste, and/or auditory actions or interactions. For example, pointing an AR enabled electronic device at the event may be one social behavior.

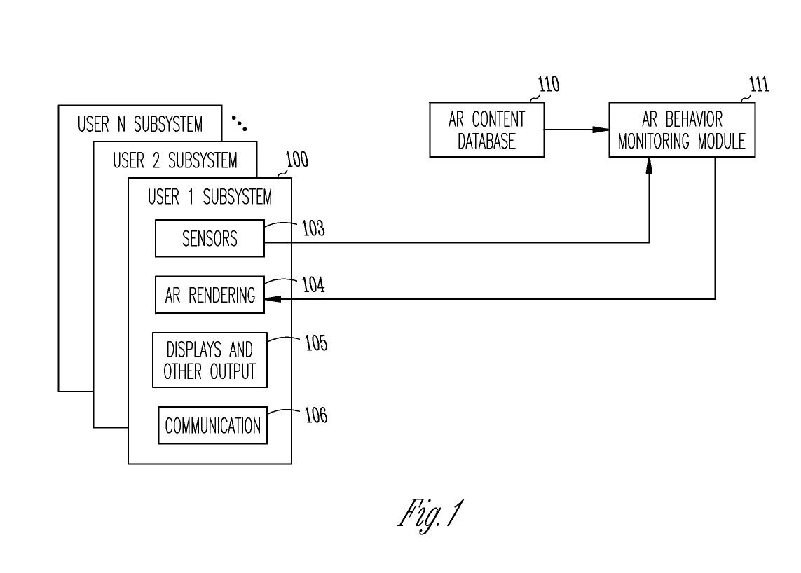

FIG. 1 illustrates a block diagram of an AR viewing system that may use various sensors (e.g., global positioning, direction sensing, gyroscope, accelerometer) in combination with social behavior monitoring in order to adjust AR content for a potential AR content user. The block diagram of FIG. 1 is for purposes of illustration only as the monitoring of social behavior to affect AR content use may be accomplished with different AR systems.

The system may include a plurality of user subsystems 100 (e.g., User (1)-User (N)), each user subsystem 100 may be associated with a different user. Each of the User (1)-User (N) subsystems 100 may include sensors 103, an AR rendering module 104, and one or more displays 105 that are carried or worn by a user. The user subsystems 100 may be incorporated into various electronic devices such as AR eyeglasses and/or other electronic devices (e.g., smartphones) that are AR content enabled.

The sensors 103 of the user subsystems 100 may include various types of sensors that enable the user subsystems 100 to sense and interact with the local environment. For example, the sensors 103 may include a global positioning system (GPS) receiver and antenna to determine the geographical location (e.g., GPS coordinates) of each user subsystem 100, one or more image sensors to capture images of the local environment, a gyroscope and accelerometer to measure movement of each user subsystem 100, and a directional sensor (e.g., compass) to determine a direction of movement and/or a direction of viewing performed by the user.

The sensors 103 of the user subsystems 100 may further include audio input/output (e.g., microphone and speaker) or haptic input/output (e.g., vibration, touchscreen). The listed sensors 103 are for purposes of illustration only. Not all of the user subsystems 100 may have the same sensors 103. Other user subsystems 100 may use other sensors 103 not listed here.

Each user subsystem 100 may further include the AR rendering module 104. The AR rendering module 104 may generate the AR graphics, text, or audio, representing the AR content, that may be combined with a real-time event being viewed by the user.

The AR rendering module 104 may be coupled to one or more displays 105 of each user subsystem 100. These displays 105 may include smartphone displays (e.g., touchscreen), liquid crystal displays (LCD), light emitting diode (LED) displays, organic LED (OLED) displays, and image projectors. For example, a user may have a pair of eyeglasses that include one or more miniature projectors that may project an image in front of the user and overlaying the event being viewed in real-time.

The AR rendering module 104 may also be coupled to other forms of output 105 that may provide a user with the AR content. For example, the other forms of output 105 may include speakers for transmitting an audio signal.

Each user subsystem 100 may further include a communications module 106 that may enable each user subsystem 100 to communicate with other user subsystems 100 and/or with other elements of the AR system that are not local to the user. The communications module 106 may include one or more radio transmitters and/or receivers that may communicate over radio channels using different standards with different frequencies. The radio transmitters and/or receivers may communicate using communication standards such as cellular standard (e.g., global system for mobile communications (GSM), time division multiple access (TDMA), code division multiple access (CDMA)), WI-FI™, and/or BLUETOOTH™.

The communications module 106 may include other forms of communication. For example, an infrared LED may be modulated with a signal to provide directional communication with nearby user subsystems 100.

The AR system may further include an AR content database 110 coupled to an AR behavior monitoring module 111. The AR behavior monitoring module 111 may accept input from the sensors 103 and transmit an output to the AR rendering module 104 for display on the one or more displays 105 of the user subsystem 100. The operation and interaction of these modules is described subsequently in greater detail.

The AR content database 110 and AR behavior monitoring module 111 may be separate from the user subsystems 100 or directly coupled to and/or part of the user subsystems 100. For example, the AR content database 110 may be stored in non-volatile memory (e.g., Flash, optical, hard disk drive) that is part of the user subsystem 100 and carried on the use.

In an embodiment, the AR content database 110 and AR behavior monitoring module 111 may be located on a central server (e.g., in the cloud) and coupled to the user subsystems 100 through a wireless connection. For example, the user subsystems 100 may have a wireless Internet connection using one or more of the above-described communication standards.

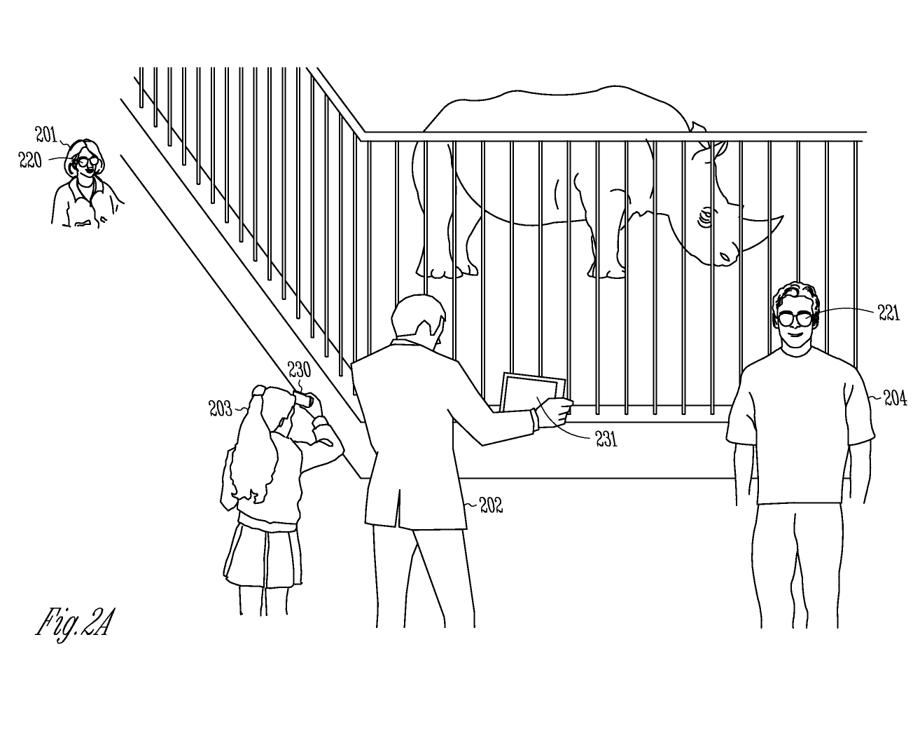

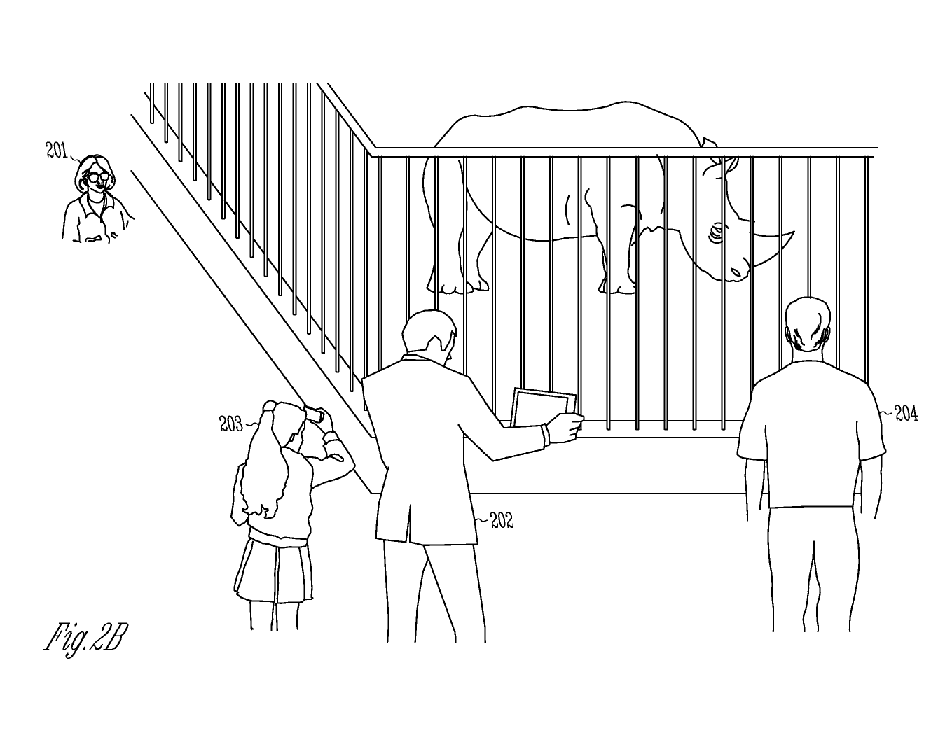

The operation of the AR system of FIG. 1 may be explained in greater detail with reference to the diagrams of FIGS. 2A and 2B. FIG. 2A illustrates an event (e.g., animal in a cage) that is being viewed by a plurality of users 201 -203. One or more of the users 201-203 may have a user subsystem 100 as seen in FIG. 1. Another user 204 may have a user subsystem 100 but is shown looking away from the event.

The users 201-204 of FIG. 2A may use different types of user subsystems 100. For example, two of the users 201, 204 are shown with wearable electronic devices (e.g., AR eyeglasses) 220, 221 that may be the user subsystem 100 that provides AR content to those users 201, 204. Another two of the users 202, 203 are shown with handheld electronic devices (e.g., smartphones) 230, 231 that may be the user subsystem 100 that provides AR content to those users 202, 203. The present embodiments are not limited to any one type of AR user subsystem.

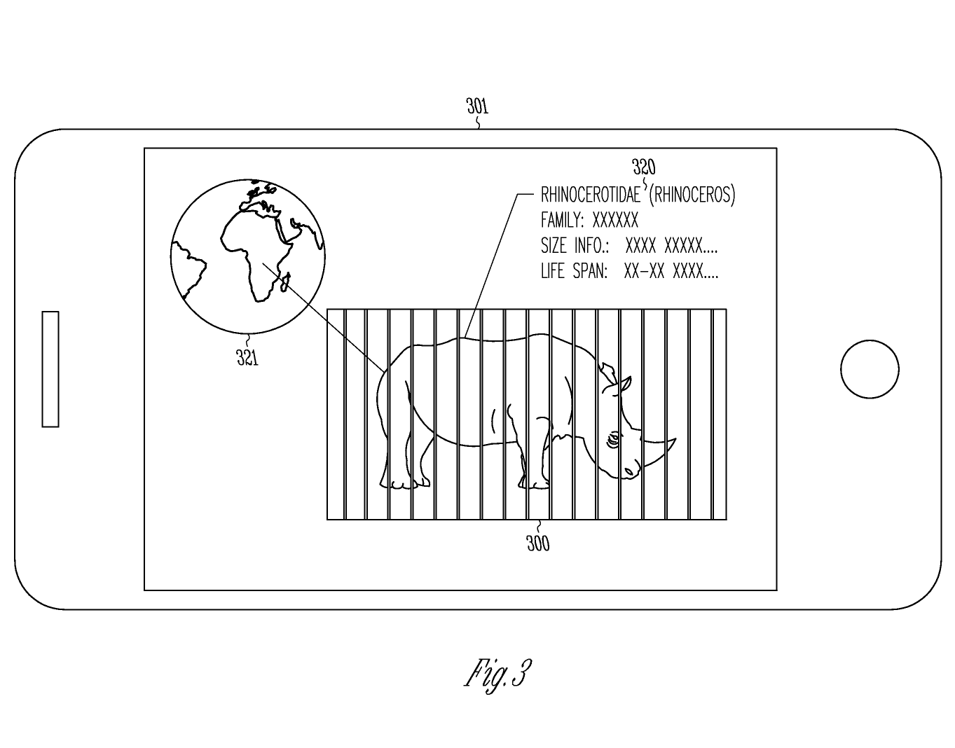

FIG. 2A shows three of the users 201-203 are viewing the event while the fourth user 204 is looking away from the event. The three users 201-203 who are viewing the event may be using their user subsystems 100 to supplement the event with AR content, as illustrated in FIG. 3.

The location of each user 201-203 may be determined by each user's location based system. The direction that each user is looking may be determined by each user's direction sensor and/or accelerometer. In another embodiment, an eye tracking sensor may be used to determine where each user is looking.

In another embodiment, the direction that each user is looking may be determined by image recognition. For example, in the embodiment of FIGS. 2A and 2B, the user subsystem may comprise a database of images. When the GPS sensor indicates that the user is located in a particular zoo, the user subsystem and/or the AR behavior monitoring module 111 may determine which animal the users are viewing by comparing an image from an image sensor 103 with images in the database of images.

The social behavior information (e.g., user location, viewing direction, image capture) may be transmitted to the AR behavior monitoring module 111 of FIG. 1. The AR behavior monitoring module 111 may then access the AR content database 110 to retrieve AR content that may be associated with that particular geographic location and viewing direction. This information may then be transmitted to the AR rendering module 104 of the user subsystem 100.

For example, text and/or graphics may be the AR content that is associated with the event to better describe what is being viewed. In the “animal in the cage” example of FIG. 2A, the AR text may inform the user of the type of animal that is being viewed and characteristics about the animal.

The fact that three of the users may be viewing the event may be noted by the AR behavior monitoring module 111. Thus, when the fourth user 204 turns his or her head (as determined using the sensors 103) to view the same event that the other users 201-203 are already viewing, as shown in FIG. 2B, the other users' social behavior may initiate or change the AR content being viewed by the fourth user 204. Thus, the AR behavior monitoring module 111, already aware that the other users 201-203 are viewing a particular event, may transmit, to the fourth user 204, the same AR content that is already being viewed by the other three users 201-203.

If the fourth user 204 is viewing other AR content as a result of his looking in another direction from the other users 201-203, the fourth user's AR content may be changed to the same AR content being viewed by the other users 201-203. If the fourth user is not viewing any AR content, the AR content for the fourth user 204 may then be initiated with the same AR content being viewed by the other users 201-203. However, the term “initiate” may cover both embodiments since even a user already viewing AR content may have their content “initiated” to the new AR content.

In an embodiment, the AR behavior monitoring module 111 may initiate or switch the fourth user 204 when only one other user 201 is viewing that same event. In another embodiment, the AR behavior monitoring module 111 may use a higher threshold of users exhibiting the same social behavior prior to switching or initiating another user to the same AR content. For example, the AR behavior monitoring module 111 may not switch the fourth user 204 until two or more other users 201, 202 are viewing that same event.

The social behavior monitored by the AR behavior monitoring module 111 is not limited to only the viewing interaction of other users. The social behavior may also include auditory and haptic behavior.

For example, if one or more first users are looking at a physical object that has an associated AR audio and/or haptic content, a second user may experience the same AR audio and/or haptic content by looking at the same object or by asking the other user(s) what they are listening to. The verbal response by the first user(s) may be interpreted by a voice sensor (e.g., microphone) and interpreted by voice recognition in either the user subsystem 100 or the AR behavior monitoring module 111. A haptic response by the first user(s) or the second user on a wearable touch surface sensor may be transmitted to the AR behavior monitoring module 111. The AR behavior monitoring module 111 may respond by transmitting the same AR content to the second user.

The above embodiments may transmit the raw collected data to the AR behavior monitoring module 111. The AR behavior monitoring module 111 may then interpret the data to determine what AR content to retrieve from the AR content database 110. In another embodiment, the raw collected data may be interpreted in the user subsystem and only conclusions transmitted to the AR behavior monitoring module 111 in order to retrieve the specific AR content from the AR content database 110.

FIG. 3 shows a diagram of an embodiment of an AR display in accordance with the embodiments of FIGS. 1 and 2. This embodiment illustrates textual 320 and iconic 321 AR content, as seen on a smartphone 301, to supplement the animal event embodiment of FIGS. 2A and 2B.

The display 300 of FIG. 3 is for purposes of illustration only as the AR content is shown in relation to a smartphone. Similar AR content may be produced on a pair of AR eyeglasses in a substantially similar manner.

The display 300 of FIG. 3 shows a block of text 420 that can explain the event (e g , animal) in greater detail. An icon 321 (e.g., animal habitat) can show a graphical representation of additional AR content regarding the event.

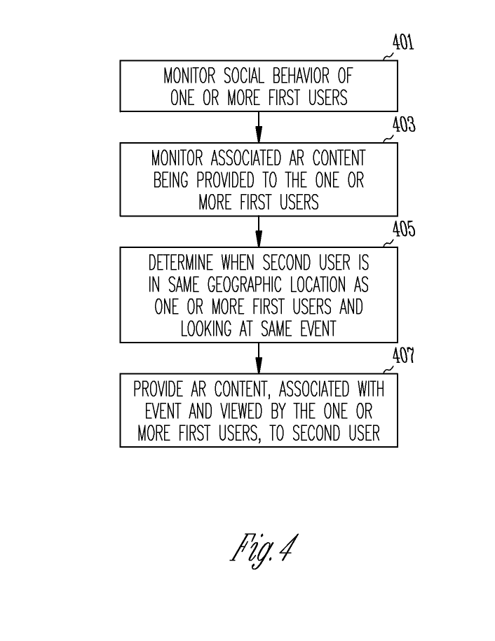

FIG. 4 illustrates a flowchart of an embodiment of a method for AR viewing initiation based on social behavior. The illustrated method may be performed by a central server configured to act as the behavior monitoring module 111 of the system of FIG. 1.

The social behavior of one or more first users is monitored 401. As previously discussed, this social behavior may include the visual, auditory, or haptic interaction with an event that may have associated AR content. The associated AR content being provided to the one or more first users may also be monitored 403.

It may then be determined when the second user is in the same geographic location as the one or more first users and looking in the same direction (e.g., looking at same event) as the one or more first users 405. Based on the social behavior of the one or more first users, the second user may be provided the same AR content that is associated with the event and is being provided to the one or more first users 407.

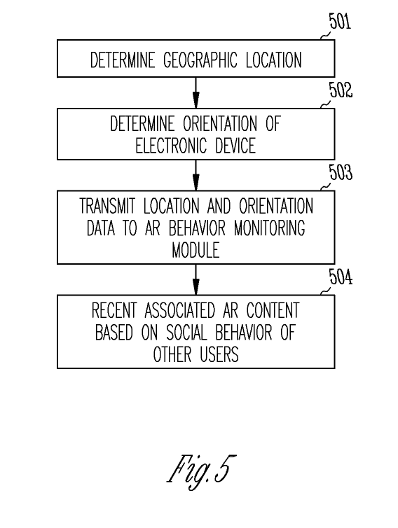

FIG. 5 illustrates a flowchart of another embodiment of a method for AR viewing initiation based on social behavior. The illustrated method may be performed by one or more of the user subsystems 100 of the system of FIG. 1.

The method determines the geographic location of the user subsystem 501. As previously discussed, this may be accomplished using one or more of the sensors 103 (e.g., GPS, accelerometer, gyroscope, direction sensor) of FIG. 1.

The orientation of an electronic device incorporating the user subsystem 100 may be determined 502. In the case of a pair of AR eyeglasses, it may be determined whether the user is looking at the relevant event. In the case of another electronic device (e.g., smartphone) that is able to receive AR content (e.g., AR enabled), it may be determined whether the user is pointing the electronic device at the relevant event.

Data representing the geographical location and orientation of the user subsystem may be transmitted to the central server (e.g., AR behavior monitoring module 111). The central server may then monitor the social behavior of other users in the same geographical area and having a substantially similar orientation for their respective electronic devices. The user subsystem may receive the associated AR content based on the social behavior of other users within the same geographical area and having substantially similar orientations for their respective electronic devices 504.

While the above embodiments of the method for AR viewing initiation based on social behavior discusses the second user being subsequent to the one or more first users, another embodiment may have the second user initiating viewing of the event substantially simultaneously with the one or more first users. Thus, the second user may then be referred to as being part of the one or more first users all viewing the same event. Thus, since it may be determined that all of the users are in the same location and looking in the same direction, as discussed previously, such that the same AR content may be transmitted to all of the users substantially simultaneously.

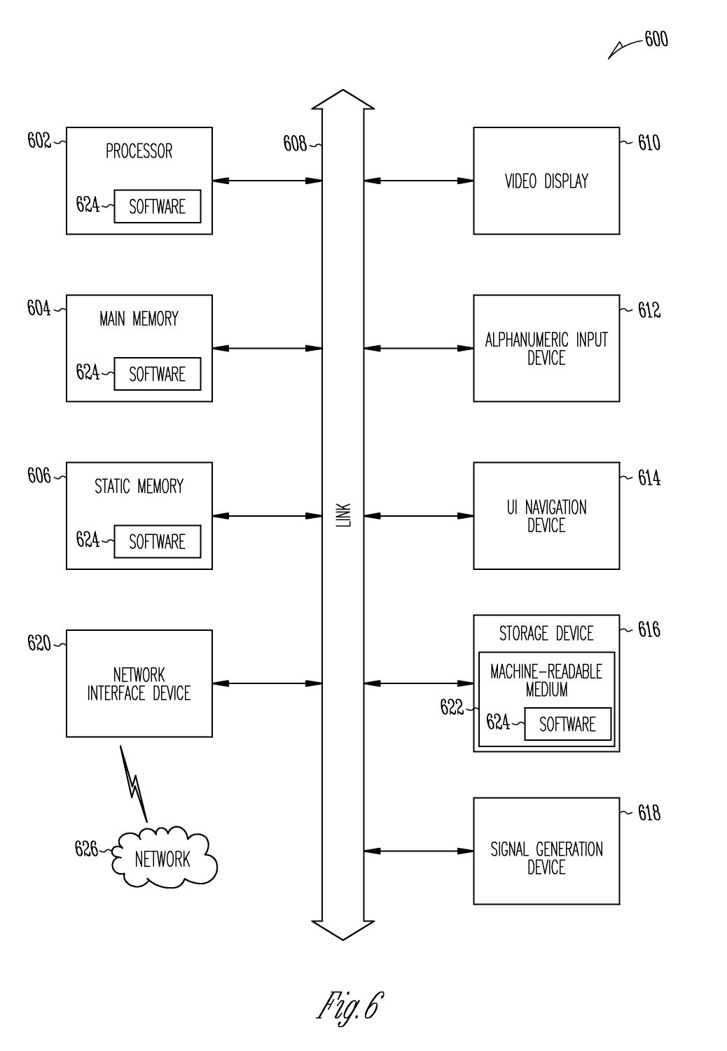

FIG. 6 is a block diagram illustrating a machine in the example form of a computer system 600, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 600 includes at least one processor 602 (e.g., a central processing unit (CPU), a graphics processing unit (GPU) or both, processor cores, compute nodes, etc.), a main memory 604 and a static memory 606, which communicate with each other via a link 608 (e.g., bus). The computer system 600 may further include a video display unit 610, an alphanumeric input device 612 (e.g., a keyboard), and a user interface (UI) navigation device 614 (e.g., a mouse). In one embodiment, the video display unit 610, input device 612 and UI navigation device 614 are incorporated into a touch screen display. The computer system 600 may additionally include a storage device 616 (e.g., a drive unit), a signal generation device 618 (e.g., a speaker), a network interface device 620, and one or more sensors (not shown), such as a global positioning system (GPS) sensor, compass, accelerometer, or other sensor.

The storage device 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604, static memory 606, and/or within the processor 602 during execution thereof by the computer system 600, with the main memory 604, static memory 606, and the processor 602 also constituting machine-readable media.

While the machine-readable medium 622 is illustrated in an example embodiment to be a single medium, the term “machine-readable medium” may include a single medium or multiple media (e.g., a centralized or distributed database, and/or associated caches and servers) that store the one or more instructions 624. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WI-FI™, 3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Modules used herein may be hardware, software, or a combination of hardware and software.

### EXAMPLES

Example 1 is an augmented reality system for receiving augmented reality content related to an event, the augmented reality system comprising: a plurality of sensors for determining a location and orientation of a subsystem of a first user in relation to the event; an augmented reality rendering module for receiving the augmented reality content that is being received by subsystems of second users having similar location and orientation of their respective subsystems, the augmented reality rendering module configured to generate at least one of graphics, text, or audio representing the received augmented reality content; and a display coupled to the augmented reality rendering module for displaying at least one of the graphics or text.

In Example 2, the subject matter of Example 1 can optionally include wherein the plurality of sensors comprise an image sensor for capturing images of the event.

In Example 3, the subject matter of Examples 1-2 can optionally include an augmented reality behavior monitoring module configured to receive the location and orientation of the subsystem from the plurality of sensors and transmit the augmented reality content to the augmented realty rendering module.

In Example 4, the subject matter of Examples 1-3 can optionally include an augmented realty content database coupled to the augmented reality behavior monitoring module.

In Example 5, the subject matter of Examples 1-4 can optionally include a communications module configured to transmit the location and orientation of the augmented reality subsystem to the augmented reality behavior monitoring module over a radio channel and receive the augmented reality content from the augmented reality behavior monitoring module over the radio channel

In Example 6, the subject matter of Examples 1-5 can optionally include wherein the subsystems comprise augmented reality eyeglasses or smartphones configured to receive the augmented reality content.

Example 7 is a method for initiating augmented reality viewing, the method comprising: monitoring social behavior of first users in response to an event having a geographical location; monitoring augmented reality content being provided to first subsystems of the first users and associated with the event; and displaying the augmented reality content on a second subsystem of a second user, having a substantially similar geographical location, in response to the social behavior and the second subsystem being oriented to view the event.

In Example 8, the subject matter of Example 7 can optionally include wherein monitoring the social behavior of the first users comprises monitoring an orientation of the first subsystems in relation to the event.

In Example 9, the subject matter of Examples 7-8 can optionally include wherein monitoring the social behavior of the first users comprises: receiving global positioning system coordinates of each of the first subsystems; and receiving orientations of each of the first subsystems in relation to the event.

In Example 10, the subject matter of Examples 7-9 can optionally include wherein receiving the orientations of each of the first subsystems comprises: receiving an image from each of the first subsystems; and comparing the image to a database of images to determine when the first subsystems are oriented to view the event.

In Example 11, the subject matter of Examples 7-10 can optionally include wherein receiving the orientations of each of the first subsystems comprises: receiving direction sensing data from each of the first subsystems.

In Example 12, the subject matter of Examples 7-11 can optionally include accessing an augmented reality content database in response to the social behavior of the one or more first plurality of users and the geographical location of the event.

In Example 13, the subject matter of Examples 7-12 can optionally include wherein the social behavior comprises an action by the one or more first users associated with the event.

In Example 14, the subject matter of Examples 7-13 can optionally include wherein the action comprises at least one of visual, haptic, smell, taste, or auditory actions.

Example 15 is an apparatus to initiate augmented reality viewing, comprising means for performing any one of the method claims 7-14.

Example 16 is a method for initiating augmented reality viewing, the method comprising: determining a geographic location for a first subsystem associated with a first user; determining an orientation of the first subsystem in relation to an event; transmitting the geographic location and orientation to a central server; and displaying augmented reality content, regarding the event, on a display of the first subsystem based on social behavior of second users having a same geographic location and receiving and displaying the augmented reality content.

In Example 17, the subject matter of Example 16 can optionally include wherein determining the orientation of the first subsystem comprises determining if the first subsystem is pointing towards the event.

In Example 18, the subject matter of Examples 16-17 can optionally include wherein determining the orientation of the first subsystem comprises determining which direction the first user is pointing an image sensor of the first subsystem.

In Example 19, the subject matter of Examples 16-18 can optionally include wherein determining the orientation of the first subsystem comprises determining a direction the first user is pointing the first subsystem in response to a direction sensor.

In Example 20, the subject matter of Examples 16-19 can optionally include receiving an aural indication from the second users as part of the social behavior.

In Example 21, the subject matter of Examples 16-20 can optionally include wherein displaying the augmented reality content, regarding the event, on the display of the first subsystem based on the social behavior of the second users comprises receiving the augmented reality content, regarding the event, to the first subsystem based on a haptic indication from the second users.

In Example 22, the subject matter of Examples 16-21 can optionally include wherein receiving the augmented reality content comprises receiving the augmented reality content over a radio channel.

In Example 23, the subject matter of Examples 16-22 can optionally include wherein displaying augmented reality content comprises playing audio content through a speaker of the first subsystem.

In Example 24, the subject matter of Examples 16-23 can optionally include wherein the social behavior of the second users comprises verbal responses.

Example 25 is a machine-readable medium comprising instructions for initiating augmented reality viewing, which when executed by a machine, cause the machine to perform any one of the method claims 16-24.

Example 26 is a computer-readable storage medium that stores instructions for initiating augmented reality viewing, in response to social behavior, in an augmented reality viewing system, operations of the system: monitor social behavior of one or more first users in response to an event having a geographical location; monitor augmented reality content being provided to first subsystems of the one or more first users and associated with the event; and transmit the augmented reality content to a second subsystem of a second user, having a substantially similar geographical location, in response to the social behavior and the second subsystem being oriented to view the event.

In Example 27, the subject matter of Example 26 can optionally include the operations further monitor the social behavior of the one or more first users and the second user through a central server.

Example 28 is an augmented reality system for receiving augmented reality content related to an event, the augmented reality system comprising: means for determining a geographic location for a first subsystem associated with a first user; means for determining an orientation of the first subsystem in relation to an event; means for transmitting the geographic location and orientation to a central server; and means for displaying augmented reality content, regarding the event, on a display of the first subsystem based on social behavior of second users having a same geographic location and receiving and displaying the augmented reality content.

In Example 29, the subject matter of Example 28 can optionally include means for determining if the first subsystem is pointing towards the event.

In Example 30, the subject matter of Examples 28-29 can optionally include means for determining which direction the first user is pointing an image sensor of the first subsystem.

In Example 31, the subject matter of Examples 28-30 can optionally include means for determining a direction the first user is pointing the first subsystem in response to a direction sensor.

In Example 32, the subject matter of Examples 28-31 can optionally include means for receiving an aural indication from the second users as part of the social behavior.

1-25. (canceled)

26. An augmented reality system for receiving augmented reality content related to an event, the augmented reality system comprising:
a plurality of sensors for determining a location and orientation of a subsystem of a first user in relation to the event;
an augmented reality rendering module for receiving the augmented reality content that is being received by subsystems of second users having similar location and orientation of their respective subsystems, the augmented reality rendering module configured to generate at least one of graphics, text, or audio representing the received augmented reality content; and
a display coupled to the augmented reality rendering module for displaying at least one of the graphics or text.

27. The augmented reality system of claim 26 wherein the plurality of sensors comprise an image sensor for capturing images of the event.

28. The augmented reality system of claim 26 further comprising an augmented reality behavior monitoring module configured to receive the location and orientation of the subsystem from the plurality of sensors and transmit the augmented reality content to the augmented realty rendering module.

29. The augmented reality system of claim 28 further comprising an augmented realty content database coupled to the augmented reality behavior monitoring module.

30. The augmented reality system of claim 28 further comprising a communications module configured to transmit the location and orientation of the augmented reality subsystem to the augmented reality behavior monitoring module over a radio channel and receive the augmented reality content from the augmented reality behavior monitoring module over the radio channel.

31. The augmented reality system of claim 26 wherein the subsystems comprise augmented reality eyeglasses or smartphones configured to receive the augmented reality content.

32. A method for initiating augmented reality viewing, the method comprising:
monitoring social behavior of first users in response to an event having a geographical location;
monitoring augmented reality content being provided to first subsystems of the first users and associated with the event; and
displaying the augmented reality content on a second subsystem of a second user, having a substantially similar geographical location, in response to the social behavior and the second subsystem being oriented to view the event.

33. The method of claim 32 wherein monitoring the social behavior of the first users comprises monitoring an orientation of the first subsystems in relation to the event.

34. The method of claim 32 wherein monitoring the social behavior of the first users comprises:
receiving global positioning system coordinates of each of the first subsystems; and
receiving orientations of each of the first subsystems in relation to the event.

35. The method of claim 34 wherein receiving the orientations of each of the first subsystems comprises:
receiving an image from each of the first subsystems; and
comparing the image to a database of images to determine when the first subsystems are oriented to view the event.

36. The method of claim 34 wherein receiving the orientations of each of the first subsystems comprises:
receiving direction sensing data from each of the first subsystems.

37. The method of claim 32 further comprising accessing an augmented reality content database in response to the social behavior of the one or more first plurality of users and the geographical location of the event.

38. The method of claim 32 wherein the social behavior comprises an action by the one or more first users associated with the event.

39. The method of claim 32 wherein the action comprises at least one of visual, haptic, smell, taste, or auditory actions.

40. A computer-readable storage medium that stores instructions for initiating augmented reality viewing, in response to social behavior, in an augmented reality viewing system, operations of the system:
monitor social behavior of first users in response to an event having a geographical location;
monitor augmented reality content being provided to first subsystems of the first users and associated with the event; and
transmit the augmented reality content to a second subsystem of a second user, having a substantially similar geographical location, in response to the social behavior and the second subsystem being oriented to view the event.

41. The computer-readable storage medium of claim 40 wherein the operations further monitor the social behavior of the first users and the second user through a central server.

42. The computer-readable storage medium of claim 40 wherein the operations further determine if the first subsystems are pointing towards the event.

43. The computer-readable storage medium of claim 40 wherein the operations further determine which direction the first user is pointing an image sensor of the first subsystems.

44. The computer-readable storage medium of claim 40 wherein the operations further determine a direction the first user is pointing the first subsystem in response to a direction sensor.

45. The computer-readable storage medium of claim 40 wherein the operations further access an augmented reality content database in response to the social behavior of the first users and the geographical location of the event.
